(19) United States
(12) Patent Application Publication
(10) Pub. No.: US 2014/0267101 A1
(43) Pub. Date: Sep. 18, 2014

(54) DISPLAY DEVICE AND METHOD FOR CONTROLLING DISPLAY DEVICE

(71) Applicant: FUJITSU LIMITED, Kawasaki-shi (JP)

(72) Inventor: SHINYA IWAKI, Kawasaki (JP)

(73) Assignee: FUJITSU LIMITED, Kawasaki-shi (JP)

(21) Appl. No.: 14/172,327

(22) Filed: Feb. 4, 2014

(30) Foreign Application Priority Data
Mar. 18, 2013 (JP) 2013-055034

(51) Int. Cl. G09G 5/00; G06T 1/20

(52) U.S. Cl. CPC G09G 5/006; G06T 1/20
USPC 345/173

(57) ABSTRACT

A display device includes a setter that sets a frequency of an operation clock of a processor that controls a display image in a window and an input to a touch panel to a first frequency and that sets the frequency to a second frequency that is higher than the first frequency when a start of a touch manipulation by a user is detected, a selector that selects a frequency at which the processor operates from among frequencies equal to or higher than the second frequency before changing the display image to another display image and that reports the selected frequency to the setter so that the frequency is set to the selected frequency, and a drawing process unit that is included in the processor and that performs a process of drawing the another display image in the window after the frequency is set to the selected frequency.

### CROSS-REFERENCE TO RELATED APPLICATION

This application is based upon and claims the benefit of priority of the prior Japanese Patent Application No. 2013-055034, filed on Mar. 18, 2013, the entire contents of which are incorporated herein by reference.

### FIELD

The embodiments discussed herein are related to a display device.

### BACKGROUND

Efforts have been made to suppress power consumption in terminal devices that are highly portable and that also function as display devices, such as mobile telephone terminals, computers, etc. For example, a technique is known that decreases a frequency at which the processor operates in a mobile telephone terminal having a touch panel when a period of time without input manipulations from a user has continued for a prescribed length of time or longer. This mobile telephone terminal increases, to the maximum, the frequency at which the processor operates when input from a user has been detected after decreasing the frequency at which the processor operates. However, in some cases, a frequency lower than the maximum frequency is sufficient to operate a processor to execute a process requested by a user. Making a processer operate at the maximum frequency even in such a case leads to higher power consumption.

An electronic device is also known that obtains the utilization ratio of a central processing unit (CPU) from a table when application software the activation of which has been detected is to be executed. This electronic device also obtains an operation frequency and an operation voltage corresponding to the CPU utilization ratio from a table, and sets the obtained operation frequency for the CPU. However, among processes executed for implementing a piece of application software, an operation frequency at which a processor is required to operate varies depending upon the types of the processes, sometimes leading to a case where a decrease in the power consumption is not sufficient.

As another related technique, a technique is also known that decreases the power consumption by decreasing the frequency at which the CPU operates when a period of time without inputs from an input device has continued for a prescribed time length or longer in a case where there are no special manipulations. Special manipulations include the pressing of a special key by a user and the execution of a special command. Further, a technique has also been proposed that permits a user to control the processing speed of a CPU. In a system using this technique, when an instruction is given by a user to increase or decrease the CPU processing speed, that instruction is reported to the power management system software so that the CPU process speed is changed.

Also, techniques disclosed by the documents below are known.
Document 1: Japanese Laid-open Patent Publication No. 2008-077563
Document 2: Japanese Laid-open Patent Publication No. 04-085609
Document 3: Japanese Laid-open Patent Publication No. 10-333773

### SUMMARY

According to an aspect of the embodiment, a display apparatus includes: a display controller configured to display a first display image in a window; a touch panel configured to receive input by a user through a touch manipulation in the window; a setter that is configured to set a frequency of an operation clock supplied to a processor that controls an image process for a display image in the window and an input reception process in the touch panel to a first frequency until the touch manipulation starts and that is configured to set the frequency to a second frequency that is higher than the first frequency when a start of the touch manipulation is detected; a selector that is configured to select a frequency at which the processor operates from among frequencies equal to or higher than the second frequency before changing a display image in the window to a second display image that is different from the first display image and that is configured to report the selected frequency to the setter so that a frequency of the operation clock is set to the selected frequency; and a drawing process unit that is included in the processor and that is configured to perform a process of drawing the second display image in the window after a frequency of the operation clock is set to the selected frequency.

The object and advantages of the embodiment will be realized and attained by means of the elements and combinations particularly pointed out in the claims.

It is to be understood that both the foregoing general description and the following detailed description are exemplary and explanatory and are not restrictive of the embodiment.

### BRIEF DESCRIPTION OF DRAWINGS

FIG. 1 illustrates an example of a hardware configuration of a display device.

FIG. 2 illustrates an example of a configuration of the display device.

FIG. 3 illustrates an example of an operation frequency table.

FIG. 4 illustrates an example of a voltage table.

FIG. 5 illustrates a table explaining examples of types of touch events.

FIG. 6A, FIG. 6B, and FIG. 6C illustrate examples of display by the display device.

FIG. 7 is a sequence diagram illustrating an example of a process performed by the display device.

FIG. 8 illustrates an example of a frequency setting table.

FIG. 9 is a flowchart illustrating an example of a process executed by the display device.

FIG. 10A and FIG. 10B illustrate examples of temporal changes in operation frequencies of a processor.

FIG. 11 illustrates an example of a frequency setting table used in a second embodiment.

FIG. 12 illustrates a table illustrating an example of a method of determining a touch manipulation.

FIG. 13 illustrates a table illustrating an example of relationships between touch manipulations and processing amounts in the processor.

FIG. 14 is a flowchart illustrating an example of a process executed in the second embodiment.

FIG. 15 illustrates an example of a table in which input sources of reports and operation frequencies are associated.

### DESCRIPTION OF EMBODIMENTS

Preferred embodiments of the present invention will be explained with reference to accompanying drawings.

FIG. 1 illustrates an example of a hardware configuration of a display device 100. The display device 100 includes a processor 200 and a graphic accelerator 101. Further, the display device 100 includes a power source 102, a clock driver 103, a Random Access Memory (RAM) 104, a touch controller 105, a touch panel 106, a Liquid Crystal Display (LCD) controller 107, and an LCD panel 108.

A processor 200 operates at variable frequencies. The processor 200 performs an application process for the display device 100. The processor 200 determines events that have occurred and determines the types of processes input by a user, as will be described. Further, the processor 200 instructs the graphic accelerator 101 to perform a drawing process on the basis of drawing data generated by the processor 200. For the processor 200, a processor is selected from among arbitrary processors including central processing units (CPUs) in accordance with implementations.

The graphic accelerator 101 performs a drawing process in response to a request from the processor 200. The graphic accelerator 101 is implemented by, for example, a graphics processing unit (GPU) etc.

The power source 102 supplies electric power to the processor 200. The power source 102 changes a voltage value of the power supplied to the processor 200 in accordance with a frequency at which the processor 200 operates. The voltage value of the power supplied by the power source 102 to the processor 200 is reported from the processor 200. The method of determining this voltage value and the like will be described later. The power source 102 changes an output voltage during a period between when the processor 200 determined to change a voltage value and when loads imposed on the processor 200 further change. For example, the power source 102 changes a voltage value of the power to be supplied to the processor 200 within 1 millisecond from when it was determined to change the voltage value in the processor 200.

The clock driver 103 outputs to the processor 200 a clock that is in accordance with the frequency at which the processor 200 operates. The clock driver 103 supplies the clock of the frequency specified by the processor 200 to the processor 200 as an operation clock. The clock driver 103 changes the frequency of the operation clock to be output during a period, e.g., 1 millisecond, between when the processor 200 determines to change the operation frequency and when loads imposed on the processor 200 further change from the time at which it was determined to change the operation frequency.

The RAM 104 stores data used for performing processes in programs and processes executed by the display device 100. The RAM 104 stores, for example, display image data 207 (see FIG. 2) drawn by the processor 200. Further, the RAM 104 stores a frequency setting table 208 (see FIG. 2). Examples and usage of the frequency setting table 208 will be explained later. Also, the display device 100 may include a read only memory (ROM, not illustrated) on an as-needed basis so as to store programs, data, etc.

The touch panel 106 receives an input process from a user. The touch controller 105 determines the position at which the input process was performed on the touch panel 106, and outputs to the processor 200 coordinate data representing the position at which the input process was performed. The touch controller 105 periodically outputs to the processor 200 a request for an interruption process and input coordinates on the touch panel 106 in a period during which input processes from a user are detected. A period at which the touch controller 105 reports coordinates to the processor 200 is set arbitrarily in accordance with implementations. For example, the touch controller 105 may be designed to report coordinates in synchronization with the refreshing process on the LCD panel 108. In such a case, the touch controller 105 reports coordinates to the processor 200 once in every 16 milliseconds under the setting where sixty frames are displayed in one second (60 frames per second (60 fps)).

FIG. 2 illustrates a configuration example of the display device 100. The processor 200 operates as a process load detector 201, a setter 202, a touch panel controller 203, a touch event detector 204, a user interface 210, and an image process unit 220. The user interface 210 includes a touch process unit 211 and a determiner 212. The image process unit 220 includes a drawing process unit 221 and a selector 222.

The process load detector 201 monitors, in a prescribed cycle, the level of loads on the processor 200 imposed by respective programs executed by the processor 200. The process load detector 201 reports to the setter 202 loads imposed on the processor 200.

The setter 202 refers to an operation frequency table when process loads imposed on the processor 200 have been reported from the process load detector 201. The setter 202 determines, on the basis of the current operation frequency of the processor 200 (the frequency of the operation clock being supplied to the processor 200) and the process loads on the processor 200, the operation frequency of the processor 200 after a change using the operation frequency table. In the explanations below, an example is used where the setter 202 holds an operation frequency table; however, the operation frequency table may be stored in the RAM 104.

FIG. 3 illustrates an example of an operation frequency table. The operation frequency table associates current operation frequencies and process loads with changed operation frequencies of the processor 200. The operation frequency table illustrated in FIG. 3 holds the minimum value of process loads for each combination of operation frequencies and changed frequencies of the processor 200.

When referring to the operation frequency table illustrated in FIG. 3, the setter 202 compares the process loads on the processor 200 and the minimum load values associated with the changed frequencies in the order from the maximum value among the changed frequencies associated with the current operation frequencies. When a process load on the processor 200 is equal to or higher than the minimum value as the comparison target, the setter 202 determines to change the operation frequency of the processor 200 to the changed frequency associated with the minimum value of the load as the comparison target. When the process load on the processor 200 is lower than the minimum value as the comparison target, the setter 202 changes the minimum value as the comparison value to the minimum value associated with a lower changed frequency, and compares the changed frequency with the process load again.

It is assumed for example that the current operation frequency of the processor 200 is 800 MHz and the level of the process load reported from the process load detector 201 is 40 percent. In such a case, the setter 202 recognizes that the maximum value of a frequency to which the current operation frequency (800 MHz) of the processor 200 can be changed is 1 GHz, and determines that the minimum value of the process load associated with 1 GHz is 90 percent. Next, the setter 202 determines whether or not the process load reported from the process load detector 201 is equal to or higher than 90 percent. The process load reported from the process load detector 201 is 40 percent, which is lower than 90 percent. Accordingly, the setter 202 determines that it is not appropriate to change the operation frequency of the processor 200 to 1 GHz, and obtains the minimum value of the load to be used for the next comparison.

In the example illustrated in FIG. 3, the candidate value of the operation frequency that is the highest next to 1 GHz is 800 MHz. Accordingly, the setter 202 compares the minimum value for 800 MHz as the changed frequency and the current process load. The minimum value associated with the changed frequency=800 MHz is 50 percent, and the process load reported from the process load detector 201 is 40 percent, and thus the setter 202 determines that it is not appropriate to change the operation frequency to 800 MHz.

Further, the setter 202 obtains the candidate value of the frequency that is the highest next to 800 MHz.

In the example illustrated in FIG. 3, the candidate value of the frequency that is the highest next to 800 MHz is 500 MHz. Accordingly, the setter 202 compares the minimum value of the load of the changed frequency=500 MHz and the level of the current load. In the example illustrated in FIG. 3, the minimum value of the load associated with the changed frequency=500 MHz is 30 percent while the process load reported from the process load detector 201 is 40 percent, and accordingly the setter 202 determines to change the operation frequency of the processor 200 to 500 MHz.

Also, in cases where the value of the frequency set for the processor 200 is not 800 MHz, the processes are executed similarly.

As will be described later, the setter 202 receives a request to change the operation frequency from the touch event detector 204 or the selector 222. The setter 202 sets the operation frequency of the processor 200 in accordance with the request to change the operation frequency input from the touch event detector 204 or the selector 222. The setting of an operation frequency in accordance with a request to change an operation frequency from the touch event detector 204 or the selector 222 will be described later. The setter 202 outputs the determined operation frequency to the clock driver 103.

The setter 202 determines the operation frequency of the processor 200 on the basis of information input from the process load detector 201, the touch event detector 204, or the selector 222, and then refers to the voltage table.

FIG. 4 illustrates an example of a voltage table. The voltage table is a table representing the relationships between operation frequencies of the processor 200 and voltage values of the power supplied to the processor 200.

The setter 202 sets, as the voltage value of the power supplied to the processor 200, the voltage that is associated with the determined operation frequency in the voltage table. For example, when the operation frequency of the processor 200 is set to 200 MHz, the setter 202 determines that the output voltage value to be set in the power source 102 is 0.90V. The setter 202 reports to the power source 102 the voltage value of the power supplied to the processor 200.

In the explanations below, an example is used where the setter 202 holds the voltage table; however, the voltage table may be stored in the RAM 104.

The touch panel controller 203 obtains, from the touch controller 105, the data of the coordinates at which an input was detected. The touch panel controller 203 outputs the data of the input coordinates to the touch event detector 204 once in a prescribed period of time. The touch event detector 204 determines the touch event that occurred on the basis of the coordinate data input from the touch panel controller 203.

FIG. 5 illustrates an example of a table that explains examples of types of touch events. In the explanations below, the touch event detector 204 detects a touch event by using a condition held as an example in the table illustrated in FIG. 5. Accordingly, when coordinates input from a user are reported from the touch panel controller 203 and the input at the reported coordinates is not included in the trace of the touch manipulation, the touch event detector 204 determines that a DOWN event has occurred. When the temporal change in the coordinates reported from the touch panel controller 203 is analyzed and the input is included in the trace of a touch manipulation that has already been detected, the touch event detector 204 determines that a MOVE event was detected. Further, when the termination of a touch event is reported from the touch panel 106 via the touch panel controller 203, the touch event detector 204 determines that an UP event was detected.

Accordingly, the touch event detector 204, the touch process unit 211, and the determiner 212 recognize that one touch manipulation continues from the detection of a DOWN event to the detection of an UP event.

The touch event detector 204 outputs the position on the touch panel 106 on which a touch event was detected and the type of the touch event to the touch process unit 211 and the determiner 212. Also, the touch event detector 204 outputs to the setter 202 a request to change a frequency on the basis of the detection of a DOWN event.

The touch process unit 211 performs a process based on application software. Further, the touch process unit 211 determines the type of the touch manipulation in accordance with a combination of the types of touch events. Examples of methods of determining the types of touch manipulations will be described later.

The determiner 212 determines whether or not to update the display of a window in accordance with manipulations by a user. The determiner 212 determines to update the display of a window when, for example, the changing amount of an input position has exceeded a threshold. In application software that is operating, when an invalid manipulation has been input or the changing amount of an input position is equal to or smaller than the threshold, the determiner 212 determines to not update the display of a window. When the determiner 212 has determined to update the display of a window, it outputs a request to update the display window to the drawing process unit 221. Also, in such a case, the determiner 212 reports to the selector 222 that a drawing process will be performed.

The drawing process unit 221 determines, in accordance with a request from the determiner 212, whether the drawing process unit 221 performs a drawing process. When the drawing process unit 221 does not perform a drawing process, the drawing process unit 221 makes a request to the graphic accelerator 101 to perform drawing. When the drawing process unit 221 performs a drawing process, the drawing process unit 221 draws display image data and outputs the result to the RAM 104. When the selector 222 has received a report from the determiner 212 that a drawing process will be performed, the selector 222 outputs to the setter 202 a request to change a frequency in the drawing process.

Also, the example illustrated in FIG. 2 represents a case where processes are implemented by operating systems, drivers, frameworks, and application software. The process load detector 201 is implemented by an operating system. The setter 202 and the touch panel controller 203 are implemented by a driver and the touch event detector 204 and the image process unit 220 are implemented by a framework. Also, the user interface 210 is implemented by application software.

### First Embodiment

FIG. 6A, FIG. 6B, and FIG. 6C illustrate display examples of the display device 100. FIG. 7 is a sequence diagram illustrating an example of a process executed by the display device 100. Hereinafter, by referring to FIG. 6A through FIG. 6C and FIG. 7, an example of a process executed by the display device 100 when a user has made an input to the touch panel 106 will be explained. The numbers representing the steps below correspond to the numbers in FIG. 7.

It is assumed in step (1) that the detection of manipulations by a user to the touch panel 106 has stopped and a drawing process and the like accompanying a user's manipulation have terminated. For example, when a user's manipulation has terminated and the drawing process of the window illustrated in FIG. 6A has terminated, the display device 100 waits for an input manipulation by a user to occur while maintaining the displayed contents illustrated in FIG. 6A on the LCD panel 108.

When a prescribed period of time has elapsed after the level of loads on the processor 200 was determined last time, the process load detector 201 determines the level of loads on the processor 200 again. In this example, the termination of the drawing process in the drawing process unit 221 has decreased the level of loads on the processor 200.

In step (2), the process load detector 201 reports to the setter 202 the level of loads on the processor 200.

In step (3), the setter 202 refers to the operation frequency table on the basis of the level of loads reported from the process load detector 201, and determines to decrease the operation frequency of the processor 200 to a prescribed value. Also, the setter 202 determines a voltage supplied to the processor 200 by referring to the voltage table. The setter 202 reports the determined operation frequency to the clock driver (CLK) 103. Further, the setter 202 reports to the power source 102 the voltage value of the power supplied to the processor 200. When, for example, the operation frequency table illustrated in FIG. 3 and the voltage table illustrated in FIG. 4 are used, the setter 202 sets the operation frequency of the processor 200 to 200 MHz and also sets the voltage value to 0.90V. The clock driver 103 outputs to the processor 200 the operation clock of the frequency reported from the setter 202. Further, the power source 102 supplies power to the processor 200 at the voltage value reported from the setter 202.

Thereafter, in step (4), as illustrated in FIG. 6B, it is assumed that a user touched the window. The touch panel 106 reports the input to the window to the touch controller 105. The touch controller 105 determines the coordinates of the position at which the input was made in the window. An arbitrary method is used for setting the coordinate system, and for example it is possible to set the origin at the upper left corner of the window, set the right side as the positive values of the X axis, and set the lower side as the positive values of the Y axis. The touch controller 105 reports to the touch panel controller 203 the coordinates of the position at which the input was made. The touch panel controller 203 reports to the touch event detector 204 the fact that an input to the touch panel 106 was detected and the position of the coordinates at which the input was made.

In step (5a), the touch event detector 204 determines the type of the touch event on the basis of a change in the coordinates reported from the touch panel controller 203. The touch event detector 204 reports the coordinates at which the touch event was detected and the type of the touch event to the touch process unit 211 and the determiner 212. In the example illustrated in FIG. 7, the touch event detector 204 outputs a signal of “DOWN” so as to report the start of a touch manipulation to the touch process unit 211 and the determiner 212.

In step (5b), when the touch event detector 204 receives a report that an input to the touch panel 106 was detected from the touch panel controller 203, it refers to the frequency setting table 208. FIG. 8 illustrates an example of the frequency setting table 208. The frequency setting table 208 records set values of operation frequencies of the processor 200 for processes executed by the processor 200. In the example illustrated in FIG. 8, the operation frequency when no processes are being executed is 200 MHz; however, 500 MHz is associated with the monitoring of a touch manipulation. Also, 1000 MHz is associated with the update process of a window. Accordingly, the touch event detector 204 requests that the setter 202 change the operation frequency of the processor 200 to 500 MHz.

When it is requested by the touch event detector 204 in step (6) that the operation frequency of the processor 200 be changed, the setter 202 sets the operation frequency of the processor 200 to the frequency requested by the touch event detector 204. In this example, the setter 202 sets the operation frequency of the processor 200 to 500 MHz in accordance with the request from the touch event detector 204. Further, accompanying the change in the operation frequency of the processor 200, the setter 202 changes the voltage value of the power supplied to the processor 200. When the voltage table illustrated in FIG. 4 is used, the setter 202 changes the voltage value from 0.90V to 1.00V.

The setter 202 reports the operation frequency of the processor 200 to the clock driver 103. Further, the setter 202 reports to the power source 102 the voltage value of the power supplied to the processor 200. Then, the value of the power supplied to the processor 200 is changed and the operation frequency supplied to the processor 200 is also changed from 200 MHz to 500 MHz.

In steps (7a) through (7e), the touch panel 106 continuously accepts an input while a user continues a touch manipulation. The touch controller 105 determines the position at which the user performed the above input process on the touch panel 106. The touch controller 105 makes a request to the touch panel controller 203 for interruption processes periodically, and reports the input position on the touch panel 106. The touch panel controller 203 periodically outputs to the touch event detector 204 the coordinates input from the touch controller 105. The touch event detector 204 determines that the touch manipulation is continuing on the basis of the input coordinates and time intervals at which the coordinates are input. The touch event detector 204 reports the continuation of the touch manipulation to the touch process unit 211 and the determiner 212. In the example illustrated in FIG. 7, when it is determined that the touch manipulation is continuing, a signal of “MOVE” is output to the touch process unit 211 and the determiner 212 together with the coordinates at which the touch manipulation was detected.

In step (8), the determiner 212 determines whether or not a change in a display on the LCD panel 108 will occur, on the basis of a change in the coordinates input from the touch event detector 204 and the types of touch events. For example, the determiner 212 determines that a change in a display on the LCD panel 108 will occur when the distance between the coordinates reported together with a “DOWN” signal and the coordinates reported together with a “MOVE” signal have exceeded a threshold. By being represented by, for example, the arrow in FIG. 6B, when a user is changing the input position on the touch panel 106 and the distance between the coordinates at which the user started the input and the coordinates at which the user is performing the input currently has exceeded the threshold, the determiner 212 determines that updating of a display on the LCD panel 108 will occur.

Hereinafter, in order to facilitate understanding, display data displayed on the LCD panel 108 is referred to as “displayed image data 207a” and data displayed after changing is referred to as “displayed image data 207b”. In other words, in the examples illustrated in FIG. 6A through FIG. 6C, the data of the image displayed in FIG. 6A is the displayed image data 207a, and the data of the image displayed in FIG. 6C is the displayed image data 207b. When the display image data 207 is to be changed, the determiner 212 makes a drawing request to the drawing process unit 221, and reports to the selector 222 that a drawing process will be performed. It is assumed that the drawing request includes information used by the drawing process unit 221 to generate the displayed image data 207b.

In step (9), it is reported by the determiner 212 that a drawing process will be performed, and the selector 222 requests that the setter 202 increase the operation frequency of the processor 200. To make this request, the selector 222 refers to the frequency setting table 208 in order to determine a frequency to be reported to the setter 202. In the frequency setting table 208 illustrated in FIG. 8, the operation frequency of the processor 200 when an updating process is being performed in a window is set to 1 GHz. Accordingly, the selector 222 requests that the setter 202 change the operation frequency of the processor 200 to 1 GHz.

In step (10), when a change in the operation frequency of the processor 200 is requested by the selector 222, the setter 202 sets the operation frequency of the processor 200 to the frequency requested by the selector 222. Because a request is made to change the operation frequency of the processor 200 to 1 GHz by the selector 222 in step (9), the setter 202 sets the operation frequency of the processor 200 to 1 GHz. Further, the setter 202 also changes the voltage value supplied to the processor 200 in accordance with the changing of the operation frequency of the processor 200. The setter 202 determines to set the voltage value to 1.30V when it refers to the voltage table illustrated in FIG. 4.

Also, the setter 202 reports the operation frequency of the processor 200 to the clock driver 103, and reports to the power source 102 the voltage supplied to the processor 200. Then, the frequency of the operation clock supplied to the processor 200 is changed from 500 MHz to 1 GHz, and the voltage of the supplied power is changed from 1.00V to 1.30V.

In step (11), the drawing process unit 221 performs a drawing process of the displayed image data 207b by using the information or the like input in step (8). It is assumed that the drawing process unit 221 continues the drawing of the displayed image data 207b while the processes of subsequent steps (12) through (15) are being executed.

In step (12), it is assumed that the input manipulation by the user terminates. The touch panel 106 reports to the touch controller 105 the termination of the input to the window. The touch controller 105 determines the coordinates or the position at which the input terminated, and reports the coordinates to the touch panel controller 203. The touch panel controller 203 reports to the touch event detector 204 the termination of the input to the touch panel 106 and the position at which the input terminated.

In step (13), when the termination of the input to the touch panel 106 is reported, the touch event detector 204 reports to the touch process unit 211 and the determiner 212 the termination of the input together with the coordinates at which the input terminated. In the example illustrated in FIG. 7, the touch event detector 204 outputs an “UP” signal so as to report the termination of the touch manipulation to the touch process unit 211 and the determiner 212.

In step (14), when a prescribed period of time has elapsed after the load on the processor 200 was determined in step (1), the process load detector 201 determines the load on the processor 200 again. In this example, it is assumed that the load on the processor 200 is 90 percent because a drawing process is being executed by the drawing process unit 221.

In step (15), the process load detector 201 reports the level of the load on the processor 200 to the setter 202. The setter 202 refers to the operation frequency table and determines the operation frequency of the processor 200 in accordance with the level of the load reported from the process load detector 201. In this example, it has been reported to the setter 202 by the process load detector 201 that the current process load on the processor 200 is 90 percent. Because the current operation frequency of the processor 200 is 1 GHz, the setter 202 compares the minimum value as the process load in a case when the frequency is not changed (the frequency after changing is still 1 GHz) and the current load on the processor 200. The current process load on the processor 200 is 90 percent, which is greater than the minimum value (80 percent) of the load that is the comparison target. Accordingly, the setter 202 determines to not change the operation frequency of the processor 200. Because the frequency at which the processor 200 operates is not changed, the setter 202 does not change the voltage.

In step (16), when the drawing of the displayed image data 207b terminates, the drawing process unit 221 stores the displayed image data 207b in the RAM 104, and reports the termination of the drawing to the LCD controller 107. The LCD controller 107 reads the displayed image data 207b from the RAM 104 and outputs the data to the LCD panel 108. Then, the display on the LCD panel 108 is changed to the contents as illustrated in FIG. 6C from the displayed image data 207a (FIG. 6A). Also, the period of time between the time when the input by the user was detected by the touch panel 106 in step (4) and the time when the changing of the display on the LCD panel 108 terminates is assumed to be within a response time required for the display device 100. For example, it is possible to set the period of time between the start of input by a user and the updating of the display on the LCD panel 108 to be within 150 milliseconds.

In step (17), the detection of a manipulation by a user on the touch panel 106 stops, and the processes after the termination of the updating of the window accompanying manipulations by a user are similar to those of steps (1) through (3).

FIG. 9 is a flowchart illustrating an example of a process executed by the display device 100.

The touch panel controller 203 waits (NO in step S1) until it obtains data from the touch controller 105. When the touch panel controller 203 has obtained data from the touch controller 105, it outputs coordinates input to the touch event detector 204 (YES in step S1).

Next, the touch event detector 204 determines whether or not a DOWN event occurred (step S2). Detection of a DOWN event by the touch event detector 204 means that a new touch manipulation has started.

Accordingly, when it has been determined that a DOWN event has occurred, the touch event detector 204 requests that the processor 200 change the operation frequency of the processor 200 to a frequency that is sufficiently high to perform the process of a touch manipulation (YES in step S2 and the process proceeds to step S3). Then, in response to the request from the touch event detector 204, the setter 202 increases the operation frequency of the processor 200 to a frequency that is sufficiently high to perform the process of a touch manipulation (step S4). Also, the setter 202 also changes the voltage value of the power supplied to the processor 200 in accordance with the change in the setting of the frequency.

When the touch event detector 204 has detected a MOVE event or an UP event, the frequency of the processor 200 has already been set to a frequency that is sufficiently high to perform the process of the touch manipulation because the touch manipulation has already started. Accordingly, when the touch event detector 204 has detected a MOVE event or an UP event, it does not request that the setter 202 change the operation frequency (NO in step S2). However, the touch event detector 204 reports the type and coordinates of the touch event to the determiner 212.

When a touch event has been detected two or more times, because the updating of the window may occur, the determiner 212 determines whether or not the updating of the window will occur by using data input from the touch event detector 204 (step S5).

When it has been determined by the determiner 212 that the updating of the window will not occur, the change in the operation frequency is not performed (NO in step S5 and the process proceeds to step S6).

When it has been determined that the updating of the window will occur, the determiner 212 requests that the drawing process unit 221 perform a drawing process and reports to the selector 222 that a drawing process will be started. The selector 222 requests that the setter 202 change the operation frequency in order to increase the operation frequency of the processor 200 to an operation frequency that is sufficiently high to perform the drawing process of the window (YES in step S5 and the process proceeds to step S7). Then, in response to the request from the selector 222, the setter 202 increases the operation frequency of the processor 200 to a frequency that is sufficiently high to perform the drawing process and also changes the voltage value of the power supplied to the processor 200 on an as-needed basis.

FIG. 10A illustrates an example of temporal changes in the operation frequency of the processor 200 included in the display device 100. FIG. 10B illustrates an example of changes in the operation frequency of the processor in the display device in which the operation frequency of the processor is increased to the maximum when a touch event has been detected. In FIG. 10A and FIG. 10B alike, the horizontal axis represents time while A through E represent points in time. Also, in FIG. 10A and FIG. 10B, it is assumed that a user's touch manipulation continues on the touch panel 106 from point in time A through point in time D.

In FIG. 10A, point in time B is the point in time at which the touch event detector 204 detected a DOWN event and requested that the setter 202 change the frequency. Point in time C is the time at which the selector 222 received a report of a process of updating the window from the determiner 212 and requested that the setter 202 change the frequency. Also, point in time E is a point in time at which the process load detector 201 reported to the setter 202 the process load on the processor 200 for the first time after the termination of the process of updating the window. Also, solid lines attached to the lines of a touch event represent examples of points in time at which touch events are detected. Also, the dashed arrows running from the lines of a touch event toward the operation frequency represent frequency setting requests in response to touch events output from the touch event detector 204 or the selector 222.

The dashed arrows running from the lines of a touch event toward the operation frequency represent messages requesting that the operation frequency be maximized on the basis of the detection of the touch events.

Also, in FIG. 10A and FIG. 10B alike, the arrows running from the lines of a process load represent that the process load is monitored in a prescribed cycle.

In a display device that changes the operation frequency of the processor to the maximum value when a touch event is detected, the processor operates at the maximum frequency from point in time B through point in time E as illustrated in FIG. 10B.

When the touch event detector 204 has detected a DOWN event, the processor 200 included in the display device 100 according to the present embodiment increases the operation frequency of the processor 200 to a frequency that is sufficiently high to monitor a touch manipulation as illustrated in FIG. 10A. Accordingly, at point in time B, the operation frequency of the processor 200 is set to a frequency that is sufficiently high to monitor touch manipulation. Further, when it has been recognized that a drawing process will occur at point in time C, the setter 202 increases the operation frequency of the processor 200 to a frequency that is sufficiently high to perform a drawing process of the processor 200. When it has been reported that the process load on the processor 200 has become lower at point in time E, the setter 202 decreases the frequency of the processor 200. Accordingly, the processor 200 may operate between points in time B and C at a frequency lower than that in a case where a drawing process is performed. Accordingly, the display device 100 according to the embodiment suppresses the power consumption in the processor in comparison with a display device that maximizes the operation frequency of the processor when a touch event is detected.

As described above, the display device 100 according to the embodiment decreases the operation frequency of the processor 200 and also decreases the power supplied to the processor 200 when the updating of the window is not performed in spite of the continuation of a touch manipulation over a long period of time or when a touch manipulation is performed only intermittently.

Also, the display device 100 according to the embodiment determines the operation frequency of the processor 200 in accordance with the types of processes performed in the processor 200 regardless of application software. Accordingly, the operation frequency of the processor 200 is adjusted more efficiently than in a case where the operation frequencies of the processor are determined for pieces of application software. Accordingly, the display device 100 according to the embodiment also adjusts efficiently the power consumed in the processor 200. It is desirable that power consumptions be adjusted efficiently in components included in a device operating without being supplied with external power such as a device carried by a user. The display device 100 according to the embodiment efficiently adjusts the power consumption, and thus the display device 100 is suitable for being included in a device that is used while being carried by a user such as for example a mobile telephone terminal, a smart phone, a tablet-type device, a computer, etc.

Further, the display device 100 according to the embodiment determines the operation frequency of the processor 200 in accordance with the types of processes performed in the processor 200 regardless of application software, eliminating the necessity of obtaining the use ratio of the processor 200 when new application software is introduced. Accordingly, the display device 100 according to the embodiment has an advantage in which it is made easier for a user to introduce new application software to the display device 100.

### Second Embodiment

A case has been explained as an example where the drawing process unit 221 performs a drawing process for the above described first embodiment; however, there is also a case where the graphic accelerator 101 performs a drawing process depending upon the types of a touch manipulation performed by a user.

When the graphic accelerator 101 performs a drawing process, the drawing process unit 221 monitors the process performed by the graphic accelerator 101 but does not perform the drawing process. Accordingly, the processing amount in the processor 200 is smaller in a case where the drawing process unit 221 performs a drawing process than in a case where the graphic accelerator 101 performs a drawing process.

Accordingly, in the second embodiment, explanations will be given for a case where the control of the operation frequency of the processor 200 is performed after the processing amount in the drawing process unit 221 is estimated in accordance with the types of a touch manipulation performed by a user.

The adjustment of the operation frequency and supplied voltage before it is determined that a drawing process will be performed is performed similarly to the first embodiment. Accordingly, the touch event detector 204 determines the types of touch events by using the same method as that in the first embodiment. Further, when a DOWN event has been detected, the touch event detector 204 determines that a new touch manipulation has started. Accordingly, the touch event detector 204 requests that the setter 202 increase the operation frequency.

FIG. 11 illustrates an example of a frequency setting table 208b used in the second embodiment. In the second embodiment, it is assumed that the touch event detector 204 refers to the frequency setting table 208b illustrated in FIG. 11.

The frequency setting table 208b records set values of frequencies in association with processes. Accordingly, when the touch event detector 204 has detected a DOWN process, the touch event detector 204 obtains a value associated with the monitoring of a touch manipulation, and requests that the setter 202 set the operation frequency of the processor 200 to 500 MHz. The change in the operation frequency in response to a request from the touch event detector 204 is performed in a manner similar to that in the first embodiment.

Similarly to the first embodiment, the touch event detector 204 reports to the touch process unit 211 and the determiner 212 the coordinates at which the touch event is occurring and the type of the touch event. The touch process unit 211 determines the type of the touch manipulation on the basis of information from the touch event detector 204.

FIG. 12 illustrates a table that explains an example of a method of determining a touch manipulation. In the explanations below, the touch process unit 211 determines the six types of actions, i.e., flicking, sliding, holding down, tapping, pinching in, and pinching out.

(A) Flicking

When a touch manipulation is flicking, the user touches the touch panel 106, changes the position of his/her finger within a prescribed period of time while keeping the finger on the touch panel 106, and thereafter stops touching the touch panel 106. Accordingly, the touch process unit 211 determines that the touch manipulation is flicking when the three conditions below are met.

The touch event transitions in the order of DOWN, MOVE, and UP.

The coordinates at which the touch event is detected changes.

The period of time between when DOWN occurred and when UP occurred is equal to or shorter than threshold Th.

It is assumed that threshold Th is set in the touch process unit 211 beforehand. Threshold Th is set arbitrarily in accordance with implementations.

(B) Sliding

When a touch manipulation is sliding, the user touches the touch panel 106 and thereafter changes the position of the finger while keeping the finger on the touch panel 106. Accordingly, the touch process unit 211 determines that the touch manipulation is sliding when the following conditions are met.

The touch event transitions in the order of DOWN and MOVE.

The coordinates at which the touch event is detected change.

When UP occurs, the period of time between when DOWN occurred and when UP occurred is longer than threshold Th.

(C) Holding Down

When a touch manipulation is holding down, the user touches the touch panel 106 and keeps the position of the finger unchanged while keeping the finger on the touch panel 106 for a prescribed period of time or longer. Accordingly, the touch process unit 211 determines that the touch manipulation is holding down when the following conditions are met.

The touch event transitions in the order of DOWN and MOVE.

The coordinates at which the touch event is detected do not change.

The period of time between when DOWN occurred and when the latest MOVE occurred is longer than threshold Th2.

It is assumed that threshold Th2 is also set in the touch process unit 211 beforehand. Also, threshold Th2 is set arbitrarily in accordance with implements, and may be a value equal to or greater than, for example, threshold Th.

(D) Tapping

When a touch manipulation is tapping, the user taps the touch panel 106. Accordingly, the touch process unit 211 determines that the touch manipulation is tapping when the following conditions are met.

The touch event transitions in the order of DOWN, MOVE, and UP.

The coordinates at which the touch event is detected do not change.

The period of time between when DOWN occurred and when UP occurred is equal to or shorter than threshold Th2.

(E) Pinching In

When a touch manipulation is pinching in, the user puts two fingers on the touch panel 106 and decreases the distance between the input positions while keeping the fingers on the touch panel 106. Accordingly, the touch process unit 211 determines that the touch manipulation is pinching in when the following conditions are met.

The touch events at two positions transition in the order of DOWN and MOVE.

The coordinates at which the touch events are detected change as time elapses so that the distance between the two points at which the touch events are detected becomes shorter.

(F) Pinching Out

When a touch manipulation is pinching out, the user puts two fingers on the touch panel 106 and increases the distance between the input positions while keeping the fingers on the touch panel 106. Accordingly, the touch process unit 211 determines that the touch manipulation is pinching out when the following conditions are met.

The touch events at two positions transition in the order of DOWN and MOVE.

The coordinates at which the touch events are detected change as time elapses so that the distance between two points at which the touch events are detected becomes longer.

The touch process unit 211 determines touch manipulations included in the table illustrated in FIG. 12 in the above described manner. The touch process unit 211 reports the result of determining a touch manipulation to the determiner 212.

The determiner 212 determines that a drawing process will occur in accordance with the temporal changes in input positions and the determined touch manipulation. Then, the determiner 212 includes the determined type of a touch manipulation in a drawing request and outputs the request to the drawing process unit 221. Further, when reporting the start of a drawing process to the selector 222, the determiner 212 also reports the type of a touch manipulation to the selector 222.

FIG. 13 illustrates a table explaining an example of relationships between touch manipulations and processing amounts of the processor. By referring to FIG. 13, relationships between touch manipulations and processing amounts of drawing occurring in the processor will be explained.

In the frequency setting table 208b illustrated in FIG. 11, different values are set as frequencies in accordance with touch manipulations performed when window updating is performed. The frequency for each touch manipulation is determined on the basis of predicted processing amounts of the processor 200, which will be explained below.

Note that it is assumed in the example below that a drawing process accompanying flicking, sliding, holding down, or tapping is performed by the graphic accelerator 101. It is also assumed that a drawing process accompanying pinching in or pinching out is performed by the drawing process unit 221.

When a touch manipulation is flicking, the touch manipulation has been finished within a period of time of threshold Th or shorter, and thus the touch manipulation has been finished when the fact that flicking was performed is reported to the drawing process unit 221 and the selector 222 from the determiner 212. In other words, when flicking has been detected, the determination of a touch event in the touch event detector 204 and the determination of a touch manipulation in the touch process unit 211 are not performed during a period during which the drawing process is being executed, and accordingly the processing amount in the processor 200 is relatively small. Accordingly, in the case of flicking, the amount of processes executed in the processor 200 is lower than those in cases of other tapping manipulations.

When a touch manipulation is sliding, holding down, or tapping, the touch manipulation has sometimes not been finished when the touch manipulation is reported from the determiner 212 to the drawing process unit 221 and the selector 222. Accordingly, when a touch manipulation is sliding, holding down, or tapping, the determination of a touch event in the touch event detector 204 and the determination of a touch manipulation in the touch process unit 211 are sometimes continued during the drawing process. Accordingly, when a touch manipulation is sliding, holding down, or tapping, the process amount in the processor 200 is middle.

When a touch manipulation is pinching in or pinching out, the drawing process unit 221 generates the display image data 207 as new data, and accordingly the drawing process unit 221 performs the drawing process. Also, when pinching in or pinching out is performed, the touch manipulation has sometimes not been finished when the touch manipulation is reported to the drawing process unit 221 and the selector 222. Accordingly, when a touch manipulation is pinching in or pinching out, the determination of a touch event in the touch event detector 204 and the determination of a touch manipulation in the touch process unit 211 are sometimes continued during the drawing process. Accordingly, when a touch manipulation is pinching in or pinching out, the process amount in the processor 200 is higher than those in cases of other touch manipulations.

In the frequency setting table 208b (FIG. 11), the relationships between the levels of setting values of frequencies are “flicking”<“sliding”, “holding down”, or “tapping”<“pinching in” or “pinching out”. This is based on the prediction of the processing amount in the processor 200, which was explained by referring to FIG. 13.

FIG. 14 is a flowchart explaining an example of a process executed in the second embodiment. Hereinafter, by referring to FIG. 14, explanations will be given for an example of a process executed after the type of a touch manipulation and the start of a drawing process are reported to the selector 222 in a case where the selector 222 refers to the frequency setting table 208b illustrated in FIG. 11.

Steps S11 through S16 illustrated in FIG. 14 are similar to steps S1 through S6 explained in FIG. 9.

When the start of a drawing process is reported from the determiner 212, the selector 222 determines whether or not the reported touch manipulation is a pinching manipulation (YES in step S15 and step S17). A pinching manipulation herein is pinching in or pinching out.

When the reported touch manipulation is pinching in or pinching out, the selector 222 reports the operation frequency associated with the pinching manipulation to the setter 202 (YES in step S17 and the process proceeds to step S18). For this reporting, the selector 222 refers to the frequency setting table 208b (FIG. 11) on an as-needed basis, and obtains the operation frequency associated with pinching manipulation. The setter 202 sets the operation frequency of the processor 200 to the operation frequency associated with the pinching manipulation in accordance with the report from the selector 222 (step S22).

When a touch manipulation reported from the determiner 212 is not pinching manipulation, the selector 222 determines whether or not the reported manipulation is flicking (NO in step S17 and the process proceeds to step S19).

When the reported touch manipulation is flicking, the selector 222 reports the operation frequency associated with flicking to the setter 202 (YES in step S19 and the process proceeds to step S20). Then, the setter 202 sets the operation frequency of the processor 200 to the operation frequency associated with flicking in accordance with the report from the selector 222 (step S22).

When the touch manipulation reported from the determiner 212 is not a pinching manipulation or a flicking manipulation, the selector 222 determines that the reported manipulation is sliding, holding down, or tapping (NO in step S19). Then, the selector 222 reports the operation frequency associated with sliding, holding down, and tapping to the setter 202 (step S21). The setter 202 sets the operation frequency of the processor 200 to the operation frequency associated with sliding, holding down, and tapping in accordance with the report from the selector 222 (step S22).

Also, after the process of step S14 or step S22 is executed, the setter 202 requests that the power source 102 change the voltage value in accordance with the changing of the frequency.

The flowchart in FIG. 14 illustrates an example of a process executed when the frequency setting table 208b illustrated in FIG. 11 is used, and the process executed by the selector 222 and the setter 202 may be modified depending upon the setting in the frequency setting table 208. For example, when different frequencies are associated with sliding, holding down, and tapping, respectively, in frequency setting table 208, the selector 222 determines that the determination result is NO in step S19, and determines the reported touch manipulation. Further, the selector 222 obtains the value of the frequency corresponding to the determined touch manipulation, and reports it to the setter 202.

In the second embodiment, the operation frequency of the processor 200 is adjusted in accordance with a prediction of a process load on the processor 200 obtained in accordance with the types of touch manipulations. Accordingly, finer adjustment is performed on operation frequencies than in the first embodiment. This leads to more flexible adjustment of power consumption in the processor 200.

<Others>

Note that embodiments of the present invention are not limited to the above described embodiments, and various modifications are allowed. Examples of such modifications are described below.

For example, it is possible to make a modification so that neither the touch event detector 204 nor the selector 222 reports to the setter 202 an operation frequency to be set in the first embodiment. In such a case, the touch event detector 204 reports to the setter 202 the fact that input was made on the touch panel 106. Also, the selector 222 reports to the setter 202 the fact that the drawing of the display image data 207 to be displayed on the LCD panel 108 will be started. When this modification is made, the setter 202 is provided with a table in which input sources of reports and operation frequencies of the processor 200 are associated. FIG. 15 illustrates an example of a table in which input source of reports and operation frequencies of the processor 200 are associated. When the table illustrated in FIG. 15 is used, the setter 202 sets the frequency for the processor 200 to 500 MHz when a report is input from the touch event detector 204. When a report is input from the selector 222, the setter 202 sets the frequency for the processor 200 to 1 GHz.

The tables illustrated in FIG. 3, FIG. 4, FIG. 8, FIG. 11, FIG. 15, and so forth are examples and may be modified in accordance with implementations.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display device comprising:
a display controller configured to display a first display image in a window;
a touch panel configured to receive input by a user through a touch manipulation in the window;
a setter that is configured to set a frequency of an operation clock supplied to a processor that controls an image process for a display image in the window and an input reception process in the touch panel to a first frequency until the touch manipulation starts and that is configured to set the frequency to a second frequency that is higher than the first frequency when a start of the touch manipulation is detected;
a selector that is configured to select a frequency at which the processor operates from among frequencies equal to or higher than the second frequency before changing a display image in the window to a second display image that is different from the first display image and that is configured to report the selected frequency to the setter so that a frequency of the operation clock is set to the selected frequency; and
a drawing process unit that is included in the processor and that is configured to perform a process of drawing the second display image in the window after a frequency of the operation clock is set to the selected frequency.

2. The display device according to claim 1, further comprising:
a frequency setting table in which candidates of frequencies of the operation clock for operations of the processor are associated with processes performed by the processor; and
a detector that is configured to detect a start of the touch manipulation by using a temporal change in a position of the input on the touch panel and that is configured to report, as the second frequency, to the setter the candidate of the frequency associated with a monitoring process of the touch manipulation by the processor in the frequency setting table, wherein
the setter changes the setting of the frequency for operations of the processor from the first frequency to the second frequency in response to a report from the detector.

3. The display device according to claim 1, further comprising:
a determiner configured to determine whether or not a display of the window is changed from the first display image to the second display image by using a temporal change in a position of the input on the touch panel; and
a frequency setting table in which candidates of frequencies of the operation clock for operations of the processor are associated with processes performed by the processor, wherein
the selector reports, as the selected frequency, to the setter the candidate of the frequency associated with a drawing process by the processor in the frequency setting table when the determiner determined that a display of the window is changed from the first display image to the second display image.

4. The display device according to claim 1, further comprising:
a touch process unit configured to determine a type of the touch manipulation by the user by using a temporal change in a position of the input on the touch panel; and
a frequency setting table in which candidates of frequencies of the operation clock for operations of the processor are associated with types of the touch manipulation determined by the touch processor, wherein
the selector reports, as the selected frequency, to the setter the candidate of the frequency associated with the type of a touch manipulation determined by the touch process unit.

5. The display device according to claim 4, further comprising
a graphic accelerator configured to support a drawing process by the processor, wherein:
the drawing process unit determines whether to perform a process in which the drawing processor generates the second display image or to perform a process in which the drawing processor requests that the graphic accelerator generate the second display image in accordance with a type of the touch manipulation; and
in the frequency setting table, a frequency associated with a first touch manipulation representing a request that the graphic accelerator generate the second display image is set to be lower than a frequency associated with a second touch manipulation representing a request that the drawing processor generate the second display image.

6. A method for controlling a display device, the method comprising:
displaying a first display image in a window;
detecting, on a touch panel, an input by a user through a touch manipulation in the window;
setting a frequency of an operation clock supplied to a processor that controls an image process for a display image in the window and an input reception process in the touch panel to a first frequency;
changing a setting of the frequency to a second frequency that is higher than the first frequency when a start of the manipulation is detected;
selecting a frequency at which the processor operates from among frequencies equal to or higher than the second frequency before changing a display image in the window to a second display image that is different from the first display image; and
making the processor perform a process for drawing the second display image in the window after a frequency of the operation clock is set to the selected frequency.

7. A computer-readable recording medium having stored therein a program for causing a computer to execute a process for controlling a display device, the process comprising:
displaying a first display image in a window;
detecting, on a touch panel, an input by a user through a touch manipulation in the window;
setting a frequency of an operation clock supplied to a processor that controls an image process for a display image in the window and an input reception process in the touch panel to a first frequency;
changing a setting of the frequency to a second frequency that is higher than the first frequency when a start of the manipulation is detected;
selecting a frequency at which the processor operates from among frequencies equal to or higher than the second frequency before changing a display image in the window to a second display image that is different from the first display image; and
making the processor perform a process for drawing the second display image in the window after a frequency of the operation clock is set to the selected frequency.
